(19) United States
(12) Patent Application Publication
(10) Pub. No.: US 2024/0251762 A1
(43) Pub. Date: Aug. 1, 2024

(54) METHOD AND SYSTEM FOR PHOTOBIOMODULATION OF POLLINATING INSECTS IN A HIVE

(71) Applicant: Beefutures Holding AS, Oslo (NO)

(72) Inventor: Christophe Philippe Brod, Oslo (NO)

(21) Appl. No.: 18/566,586

(22) PCT Filed: Jun. 3, 2022
(86) PCT No.: PCT/NO2022/050124

§ 371 Date: Dec. 1, 2023

(30) Foreign Application Priority Data
Jun. 4, 2021 (NO) 20210713

(51) Int. Cl. A01K 51/00

(52) U.S. Cl. CPC A01K 51/00

(57) ABSTRACT

A method and system for exposing pollinators in a hive to photobiomodulation, including a device that emits infrared light with a predetermined radiant energy that received by a surface per unit area over time between and is a configurable by a schedule system.

### FIELD OF THE INVENTION

The present invention relates to a system and method for photobiomodulation of pollinating insects in a hive.

### BACKGROUND OF THE INVENTION

The number of bees in the world is dropping dramatically each year and estimates show that up to a third of Europe's bee population and a fourth of Europe's bumble bee population are endangered. Given that bees pollinate around one-third of food crops and 90 percent of wild plants, the consequences of this ecological disaster are alarming for biodiversity, the food chain and, not least, our ability to feed ourselves. The bee's pollination contributes to up to 30% of the world's fruit and vegetable production and animal feed for grazing animals. A reduction in bee population is thus a sharp reduction in food production.

The cause for this is likely linked to an un-unprecedented sum of challenges. While some of the threats are individually fatal for bees, it is surely the cocktail of multiple stressing and pressing factors which is causing their dramatic downfall, among them is the colony collapse disorder (CCD).

Recent founds show that when bees eat a low sugar diet, which is typically the case in winter or in intensive low biodiversity agriculture areas, the bees are 50 percent more likely to die as a result of neonicotinoid exposure. And it is this cocktail of hostile environments that seems to cause the bees to become weaker from neonicotinoids together with an energy poor diet, causing them to not have the necessary energy to travel the necessary distances to gather food, losing even more energy and finally being killed in large numbers by enemies or dying from exhaustion.

The research article “Improving Mitochondrial Function Protects Bumblebees from Neonicotinoid Pesticides” by Powner et al. published in 2016 has shown that exposing bumblebees (Bombus terrestris audax) with near infrared light with a wavelength of 670 nm may increase their mitochondrial production of adenosine triphosphate (ATP). Corrected ATP levels in individuals exposed to insecticides such as neonicotinoids showed significant improvements in mobility allowing them to feed. The article teaches that deep red-light exposure improves mitochondrial function, reverses the sensory and motor deficits induced by neonicotinoids. The test was carried out by placing the bees in a transparent plastic container and exposing the bumblebees to light. The article estimates that the true impact of this deep red light is likely much greater than revealed in the ATP and Metabolic functions tests.

The study “Neonicotinoids Disrupt Circadian Rhythms and Sleep in Honey Bees” by M. C. Teckenberg et al published in 2020 suggest that neonicotinoids alter the circadian rhythm of honeybees and further honeybees exposed to neonicotinoids prolonged their active period well into the dark phase following lights off, and increased their activity at night. Furthermore, the study exposed the honeybees for continuous light and it suggests that continuous light input and neonicotinoids in altering honeybee circadian behaviors.

The article “Biphasic Dose Response in Low Level Light Therapy” by Y. Huang et al published 2011 Nov. 2 discloses that the first law of photobiology states that photons of light must be absorbed by some molecule (called a chromophore) located within the tissue to have any biological effect. Tiina Karu working in Russia and Salvatore Passarella in Italy were the first to suggest that one of the principal chromophores responsible for the beneficial effects of Photo Bio Modulation (PBM) was located inside mitochondria. Low level light therapy, or low level laser therapy (LLLT) and photobiomodulation are terms that are often used for phototherapy that is characterized by its ability to induce photobiological processes in cells. The effective tissue penetration of light and the specific wavelength of light absorbed by photoacceptors are two of the major parameters to be considered in light therapy. In tissue there is an “optical window” that runs approximately from 650 nm to 1200 nm where the effective tissue penetration of light is maximized (Huang et al. 2011).

Photobiomodulation is meant to protect and restore mitochondria function that has been undermined with stress and age. Among the stresses are pesticides/neonics but also cold and heat induced by long transportation stages of bees and climate disturbances. However, it is documented that overexposure of photobiomodulation for bees and insects may have a harmful effect.

In summary, LLLT or photobiomodulation can have inhibitory or stimulatory effects even at the same wavelength with just the use of a much higher energy density. The energy density is controlled by the amount of light received by an area for a certain amount of time. This is thus dependent on the level of crowdedness in a hive, the duration of the exposure and how often the exposure occurs. This principle states that a very low dose of light has no effect, a somewhat bigger dose has a positive effect until a plateau is reached. If the light dose is increased beyond that point the benefit progressively decreases, until the baseline (no effect) is reached, and further increases will actually start to have damaging effects on the tissue. This curve is well known in the field of toxicology, where the phenomenon is called “hormesis”. Part of the explanation of this “U” or “J” shaped curve is that small doses of a potentially toxic drug or harmful intervention can induce expression inside the cells of a range of protective factors such as anti-oxidant enzymes and anti-apoptotic proteins that will enhance normal function and protect against subsequent lethal challenges.

The drawbacks of the known methods are that it is impossible to treat or heal bees in the wild and the optimum exposure required in a hive is not known, which could result in causing harm and more damage to a population if wrongly executed (measured and documented by the applicant). It is also believed that the method did not control for, or the test was not aimed at, all the benefits of light exposure.

These benefits are increased mobility, improved immunity, reduced oxidation at cellular level, improved retinal function and memory of the bees, and improved respiration as well as a result of mitochondrial function improvement. Test carried out has also demonstrated increased metabolic metrics improvement for bee colonies exposed to other stress factors such as Asian Hornet, Varroa mite and dearth period.

The patent application WO 2018/165051 A1 teaches a translucent hive for treating honeybee colonies against destructive insects such as Varroa. The translucent hive has at least one outer wall transparent to light from the outside. In another embodiment disclosed in WO 2018/165051 A1 an illuminator board 1900 is placed under a translucent wall in the bottom of the hive. The teachings of WO 2018/165051 A1 has the drawbacks of hindering the natural flow of bees as the bottom board stop bees from entering and exiting the compartment from the bottom. Further drawback of the known prior art is the poor illumination of the bees and the lack of control of over or under exposure.

None of the above documents or teaching disclose the length of time for an exposure, and even more crucial, at what time of the day the exposure is to occur and how often. A research article from Guy Bloch, Noam Bar-Shai, Yotam Cytter and Rachel Green called “Time is honey: circadian clocks of bees and flowers and how their interactions may influence ecological communities” teaches that bees are “Relying on the circadian clock to anticipate the time of sunset and sunrise may enable diurnal bees to most efficiently exploit the hours with sufficient sunlight for foraging.” and that “internal clocks influence activity rhythms in bees are the observations that individually isolated foragers of bumblebees and honeybees typically show strong circadian rhythms in locomotor activity with higher levels of activity during the day even when kept under constant laboratory conditions. It is clear from the research that bees in general have strong circadian rhythms even when they cannot see the daylight and that this rhythm is connected to their activity level. The research article “Circadian Rhythms and Mitochondria: Connecting the Dots” by Sardon et al. published Aug. 20, 2018 claims that there is an “intimate and reciprocal relationship between the metabolic status of the cell/organism and the circadian clock.” and that “Mitochondria are one of the major cellular nodes for nutrient integration and ATP generation. Mitochondria are therefore highly dynamic, and their activities change according to the cell nutritional status at different times of the day.” and “Because mitochondria are central to metabolic integration and can regulate transcription mechanisms, it is likely that one or several mechanisms link mitochondrial function to circadian rhythms.” It is therefore clear from the article that there is a direct link between the circadian cycle and the mitochondria activity. However, none of the articles exposes how the connection between the circadian cycle and the mitochondria activity may be used to treat pollinators for a variety of illnesses and treatments nor how to improve and recover energy and mobility of pollinators. Furthermore, none of the prior teaching facilitates for a treatment device and method that treats the pollinators when they are most receptive to treatment.

The light exposure duration, repetition rate/frequency and time of the day is therefore critical to ensure maximum biological response and ensure appropriate fluence.

It is an aim of the present invention to treat pollinating insects when they are at their most active and according to their circadian rhythm and according to the pathology or challenge being treated and according to the size of the pollinator colony. With appropriate schedule and exposure amount, low level laser therapy in the form of light exposure of the pollinators in their hive allows to further protect and restore challenged mitochondria in the pollinator insects' cells. With increased energy levels, lower inflammatory cell state, increased and respiration and immunity, the pollinators are able to survive a myriad of stresses: due to lack of food, old age, chill and heat chocks stresses, pesticides stresses and other diseases together with improved metabolism and motivation and energy to fight parasites and predators. It is further an aim of the present invention to correctly expose pollinating insects, thereby to ensure maximum biological response and avoid damage by incorrect treatment and overexposure. Timing and the amount of light (fluence) of the exposure is of paramount importance and is both season and pollinator colony size dependent. The solution disclosed herein ensures optimal biological response by adapting exposure time of the day, and duration depending and interval schedules, where all three parameters are variables depending on the time of the year, and the pollinator colony size and its activity level.

### SUMMARY OF THE INVENTION

The invention is set forth and characterized in the main claims, while the dependent claims describe other characteristics of the invention.

### BRIEF DESCRIPTION OF THE DRAWINGS

FIG. 1 shows a section view of a hive

FIG. 2 shows a section view of a typical bumblebee hive

FIG. 3a shows a section view of a hive comprising frames and a cluster of pollinators

FIG. 3b shows a section view of a hive comprising frames and a cluster of pollinators

FIG. 4 shows a graph estimating the growth and decline of a bee colony during a year

### DETAILED DISCLOSURE OF THE INVENTION

The following description will use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting. It should be understood that the terms pollinators, pollinating insects or insect pollinators is used for bees, honey bees, bumblebees, osmia bees and other insects cultivated and managed by humans in hives. And the use of either bee or honeybee is for the reader's convenience only and shall not be limiting. A hive is any man-made structure or artificial nest used to cultivated and managed pollinating insects.

There exists a large variety of different commercial/human made hives, these are honeybee hives, bumble bee hives, osmia bee hives, mason bees hives etc. . . . . All hives physical characteristics and dimensions are specific to the pollinators type and their community characteristics.

For honeybees there is two main categories; vertical hooves or horizontal hives. The most typical types of hives honeybees are Langstroth hive, Dadant hive, Warré hive, WBC hives, CDB hives, Perone hives, Norwegian standard hive, UK standard hive and German standard hive. In patent EP 3041349 B1 a list of hives and measurements for the hives are listed in Table 1. All of these hives may be used in a system in accordance with the embodiments of the invention defined in the claims.

Hives adapted for osima bees and bumblebees are often of simpler construction than hives adapted for honeybees. Bumblebee hives does not have frames and may be comprised of only one hive compartment box and an entrance and exit, and osima bee hives comprise multiple holes or tunnels in an otherwise solid construction. It should be understood that the light therapy device in accordance with the disclosure herein may also be used on hives for bumblebee hives and osima beehives.

The photobiomodulation device disclosed herein for pollinator hives comprises a low-light laser source in the form of a stimulated emission or of radiation device or at least a light emitting diode (LED) and a schedule and light fluence control. The photobiomodulation device emits infrared or close to infrared light with a wavelength of preferably between 620-1000 nm, and more preferably between 640-700 nm, and even more preferably between 640-680 nm. The LED as comprised in the light device, should preferably be capable of emitting light where at least 68.26% of the light emitted has wavelength of between 660-680 nm or more preferably at least 95.44% of the light emitted has a wavelength of 660-680 nm. Alternatively, the peak wavelength λₚ should be around 670 nm in a spectral power distribution. A spectral power distribution refers to the concentration of wavelength of radiometric or photometric quantity, and in this case, the peak wavelength of a spectral power distribution should be understood as the wavelength with the highest power per unit area per unit wavelength of an illumination.

Fluence, or radiant exposure, is the radiant energy received by a surface per unit area, or equivalently the irradiance of a surface, integrated over time of irradiation. As the radiant exposure, or fluence, is expressed by joule per square meter (J/m2), the irradiance is expressed as joule per square meter over time (W/m2) or milliwatt per square centimeter (mW/cm2). Photobiomodulation device for the invention is preferably adapted to expose the pollinators within the hive with a fluence or irradiance between 28 mJ/cm2 to 45 mJ/cm2 or 28 mW/cm2 to 45 mW/cm2.

In an embodiment the invention relates to a method for exposing pollinators in a hive to photobiomodulation. It should be understood that any type of pollinator i.e. an animal that moves pollen from one flower to another flower, and any type of hive suitable to house said pollinators may be used for the inviting. To achieve photobiomodulation a photobiomodulation device comprising at least one light or laser source capable of emitting stimulated emission of radiation or at a device comprising a light emitting diode (LED), may be used. The device is situated in a manner capable of irradiating the pollinators inside the hive. For hives with multiple brood boxes and frames the device may comprise multiple light or laser sources. For simpler hives, such as for bumble bees, only one light source may be needed, but a device comprising several light sources may also be used. The device should be situated inside the hive to expose the insects for predetermined exposure times of the day, intervals and redetermined fluences. The exposure time(s) and intervals are determined by at least one of: the circadian rhythm of pollinating insects, the time of year, the geographical location of the hive, the amount of insect individuals in a hive, the presence of external factor such as the presence of hostile predators and pollution.

The effect of the automatically controlled control of the light therapy device is both to expose the bees to light at optimal times, and to reduce exposer when it might not be beneficial. At times, it might not be optimal to ensure the longevity of old bees by way of the present invention, but rather promote the queen bee to lay eggs. For instance, if a bee colony is not particularly stressed or there is no particular sign of decline, the light therapy device will facilitate to keep old bees alive longer than normal and cause the colony to be too large at a peak point. The queen may regulate the situation by stopping laying eggs or bees themselves might trigger a swarm because of storage and space lack in a hive. In other words, if there is no sign of colony decline it might not be desirable to treat the bees with light as it could trigger abnormal colony evolution and negative side effects. To ensure that the correct timing of light exposure, the light therapy device may comprise a control device which receives input from at least one sensor, as described above.

To attain optimum effect from the photobiomodulation treatment, the exposure should occur when the circadian rhythm of the pollinating insects is most receptive for photobiomodulation. Hence, the photobiomodulation treatment should be timed in accordance with the sunrise and possibly the sunset. Thus, the optimum time for exposure is dependent on the time of the year and the geographical location. The time of sunrise (Ts) at the geographical location of the hive at a specific time of the year is readily available, for instance via websites such as https://www.sunrise-and-sunset.com and should be known by a person skilled in the art. The photobiomodulation device may be outfitted with an GPS device and a time keeping device, that may calculate the time of sunrise Ts based on where the hive is situated. Furthermore, to determine, i.e. configure, the length of the exposure, i.e. the time T1 after Ts the device is turned on to irradiate the pollinators, and the time T2 after T1 the device is turned off to end the exposure may be dependent on a multitude of factors. The invention may thus be comprised of a configurable schedule system comprising a GPS device, a time keeping device and a control system to schedule and control the light emittance. The controlling device of the schedule system is adapted to turn the device on or off based on the schedule decided by the system and method disclosed herein. The term configurable should be understood as being able, and/or adapted to, determine, control and/or configure a set of parameters, such as timing, duration, effect and wavelength.

The impact factors may be cold and wet weather, dearth/lack of food, chemicals or pollution exposure, transportation of hives and/or colonies, presence of parasites, time of year, age of pollinators, diseases or foraging activity.

These factors have a great influence on the pollinators, for instance, during the winter, autumn and also in some cold spring months or during times with dearth/lack of food. For pollinators, any time outside of the blooming and nectar flows, dearth is particularly detrimental when the colony is in expansion. Chemicals are, as disclosed in the background of the invention, harmful for pollinators and are spread on crops for various reasons and also used by beekeepers for pest management. Pesticides accumulate in the hive and are detrimental to the pollinators.

During a year the presence of parasites varies immensely, and although they are found all year, the number of varroas increases drastically from June to November along the increase in number of pollinators in a hive. During this increase of both numbers of pollinators and varroas, the predetermined exposure times must increase. Furthermore, during a yearlong cycle, as the age of the pollinators increases the pollinators becomes more susceptible to diseases. The average age of the pollinators in a hive is highest at the end of the winter, before new pollinators are hatched and the colony rebounds with a new young and healthy workforce. Furthermore, the pollinators are from summer to winter bee colony conversion: a crucial period of time for bees when all summer bees die and winter bees are born, failing in the transition means the end of the colony if older summer bees die too

During the spring and summer, the pollinators are foraging, which is energy demanding for the pollinators, and an increased irradiation exposure may be needed. For the invention a reference time of T1+T2 is set for a predetermined exposure duration, wherein T1 may be from 15-60 min, and T2 may be 30-90.

In situations where any of the above-mentioned factors occurs, the length of the irradiation exposure can be increased, from T2 to T3 in situations wherein fewer bees are present in the hive compared to a reference number and/or the pollinators are not subjected to any of the factors the length of the irradiation exposer can be decreased, from T2 to T4, wherein T4 may be 15-60. As the effect of photons absorbed by the cytochrome lasts for a certain period of time (somewhere between 3 to 8 days), the interval of the exposure may be repeated.

During the transportation of pollinators, which occurs several times during pollination and throughout the season to relocate the pollinators to new locations, the pollinators experience enormous strain. Therefore, if a beekeeper plans to move his pollinators on truck, the beekeeper may need to treat the pollinators with photobiomodulation treatment 2 weeks ahead of the move with 3 to 4 days intervals to be sure that a sufficient number of bees have got an effective irradiation dose. To further strengthen the bees the beekeeper, need to treat the bees afterwards relocation as well. For example, in situations where relocation is planned, the time of the exposure may increase and wherein the device is turned on to irradiate a predetermined time Ts+T1, and is turned off after a predetermined time Ts+T1+T3, wherein T3 is longer than T2, and wherein T2 is a reference time for irradiation. The reference time may be set by a user with a healthy colony of pollinators at any time, for other times to be calculated from. And if the colony of pollinators, i.e. the number of pollinators in a hive, increases from during a period of time, the predetermined time for when the irradiation exposure by the device is ended is delayed until Ts+T1+T3. Furthermore, any of the impact factors mentioned herein may result in a longer exposure time. In another scenario, the colony of pollinators may have decreased, and the previous exposure Ts+T1+T2 might be harmful for the number of pollinators, so a shorter time of exposure is used.

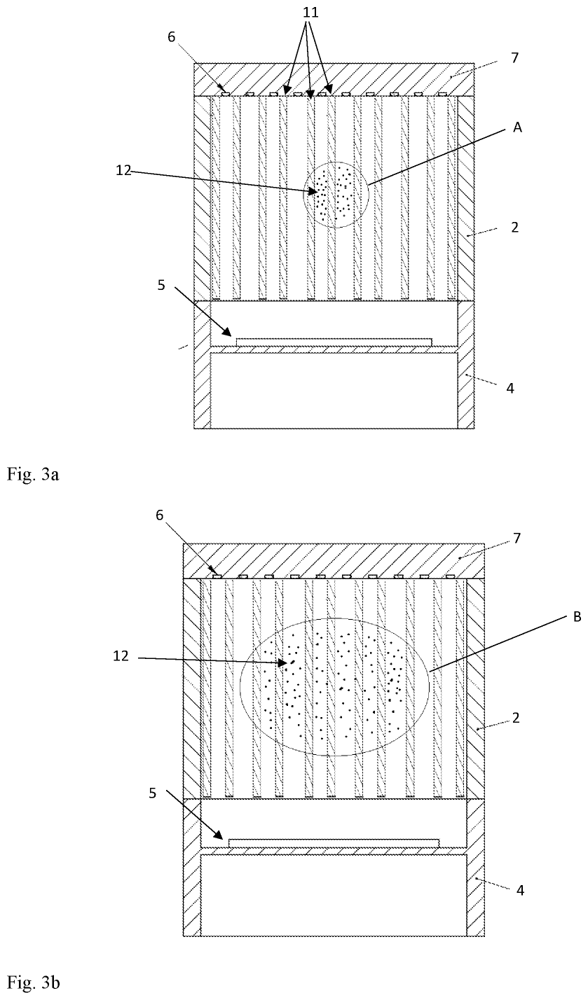

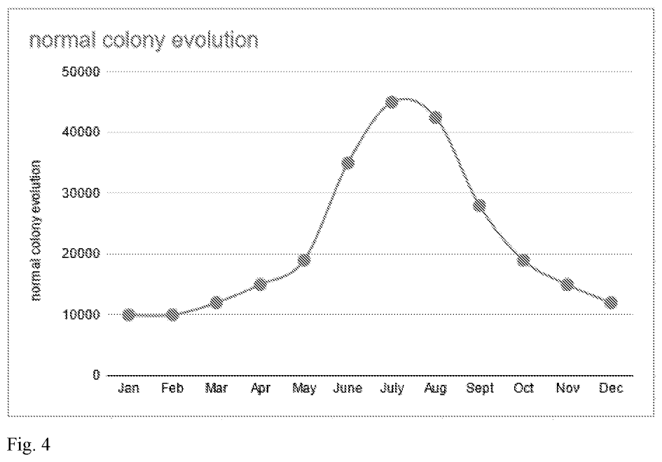

In an embodiment of the invention a method is provided to irradiate the insects for different predetermined times, wherein a user, for instance a beekeeper, takes a measure of the pollinators to get a base measure of the number of pollinators. This may be performed by a weight device attached to the hive, and by knowing the weight of the hive without pollinators inside, the given with pollinators inside can give an estimate of the number of pollinators. Other means of measuring the number on pollinators inside the hive may be used as well, such as a rough estimate by a table or the graph in FIG. 4. A further way of measuring the numbers of pollinators inside a hive may be in connection with the number of brood frames inside the hive the pollinators are populated with pollinators. As the pollinators stay grouped inside the hive, the reach of the group of bees may be used as an estimate for a measured size of the colony. Hives may have up to 8 to 12 depending on the hive standard. In the spring, the group of pollinators may span 2-3 frames inside the hive, as illustrated in FIG. 3a, and increase the expansion of the group up to the maximum number of frames used in the hive. In FIG. 3b the group of pollinators 12 is illustrated to span over seven frames. As the colder season is approaching the span of the group of pollinators will start to decrease the number of frames they occupy in the hive. As a result of this the first and further measures of the hive can correlate to the numbers of frames occupied by the pollinators. A user, typically a beekeeper, can either visually look inside the hive or use a camera positioned inside the hive to determine the number of frames occupied by the pollinators. The system may therefore comprise means to determine the size of the colony inside the hive, either by weight, number of frames occupied, estimates or the like. The means for determining the size of the colony bay be a visual sensor, such as a camera or infrared detector device that detects or it may be an acoustic sensor that is adapted to estimate the number of pollinators based on the sound level detected. If one of the impact factors occurs, and the need for photobiomodulation treatment is present, the system and method may be employed in the following way. For a first measured size of the colony inside the hive, for example when pollinator occupying 3 frames inside the hive as illustrated by section A, the photobiomodulation device is turned on to irradiate the insects for a predetermined time Ts+T1 and is turned off after a predetermined time Ts+T1+T2. For example, if the time of sunrise Ts at the specific location is 06:00 and T1=30 min and T2=30 min, the device will start to irradiate inside the hive at Ts+T1=06:30 and stop (turn off) at Ts+T1+T2=7:00. When the user at a later time, measures the number of pollinators inside the hive and records a further measured size of the colony inside the hive, for example pollinator occupying 7 frames inside the hive as illustrated by section B, the further measure is larger than the first measure, a longer photobiomodulation exposure is needed to get the same amount of fluence on each pollinator. It that situation a time T3 may replace the initial referenced time T2, wherein in this example, T3=45 min. Then the device is turned on to irradiate a predetermined time Ts+T1, which is in this example 06:30, and is turned off after a predetermined time Ts+T1+T3, which is =07:45. To avoid over exposure, if the further measured size of the colony inside the hive is smaller than the first measure, for example pollinator occupying 2 frames inside the hive, the device is turned on to irradiate a predetermined time Ts+T1, and is turned off after a predetermined time Ts+T1+T4, wherein T4 is shorter than T2. It that situation a time T4 may replace the initial referenced time T2, wherein in this example, T4=15 min. Then the device is turned on to irradiate a predetermined time Ts+T1, which is in this example 06:30, and is turned off after a predetermined time Ts+T1+T4, which is =06:45.

Furthermore, if any of the impact factors mentioned herein occurs, for instance if a cold weather set in, a chemical is used nearby or number of varroa increases, a user or the system itself may prolong the exposure from T2 to T3 based on measurements taken that may determine such factors. In situations where one of the impact factors are detected in addition to another factor or situation, the irradiation exposure can be increased, from any of the previous durations T2, T3 or T4 to T5, wherein T5 is any time longer than the previous irritation time. For instance, if the system has detected that the colony has grown from a first measure of spanning four frames, to a second measure where it spans nine frames, so an irradiation exposure of turning on at Ts+T1 and turning off at Ts+T1+T3 is determined, but an impact factor is detected, for instance the presence of pesticides, the turn off time may be prolonged to Ts+T1+T5, wherein T5 is longer that T3. The scheduler system decides, hence configures, the duration of Ts, T1, T2, T3, T4 T5 and based on the geographical location, time of year and the external factors in relation to the hive, the surroundings and the pollinators, as disclosed herein.

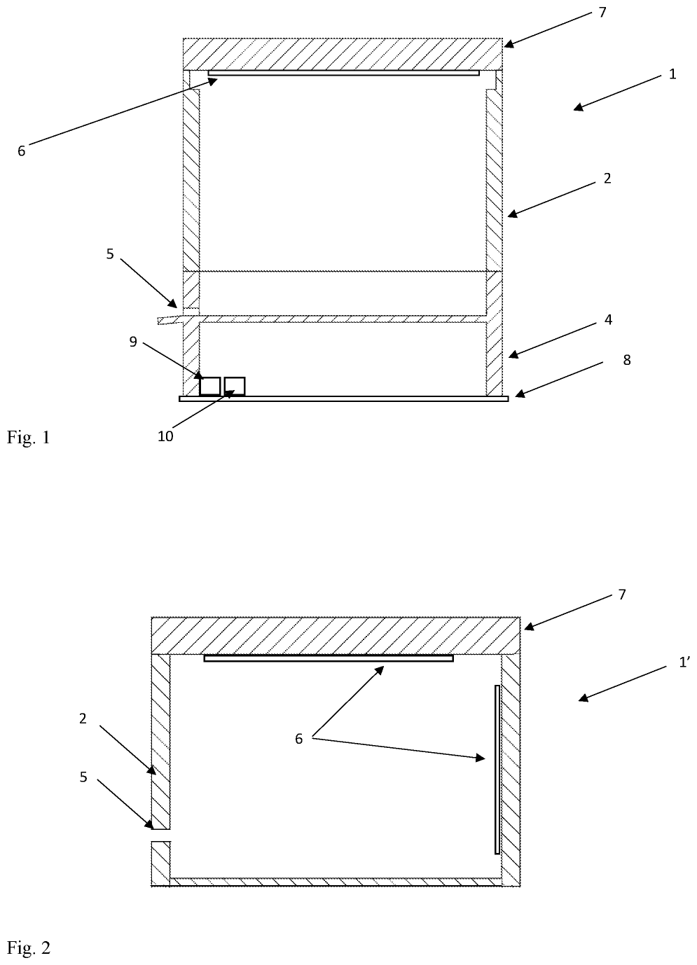

FIG. 1 illustrates a typical artificial hive 1 used for pollinators such as bees while FIG. 2 illustrates a typical artificial hive 1′ used for pollinators such as bumblebees. The hive 1 in FIG. 1 comprises an entrance chamber box 4 typically known as a bottom board with an entrance 5 for pollinator to enter and exit the hive. On top of the bottom board 4 is the hive compartment box 2 typically known as a brood box. The top of the bottom board 4 and bottom of the hive compartment box 2 is open to create an opening for pollinators to freely move between the bottom board 4 and hive compartment box 2. On top of the hive compartment box 2 is a removable top cover 7 to cover the top. The hive compartment box 2 normally comprises frames (illustrated in FIG. 3). In FIG. 1 a photobiomodulation device 6 is situated on the bottom of the top cover 7, but it should be understood that the photobiomodulation device 6 may be situated at any location in or inside the hive 1 or parts thereof. The alternative hive 1′ in FIG. 2 comprises a hive compartment box 2 comprising an opening 5. On top of the hive compartment box 2 is a removable top cover 7. In the FIG. 2 the hive 1′ comprises two photobiomodulation devices 6, 6′ situated inside the hive compartment box 2, a first 6 on the downward facing side of the top cover 7 and a second 6′ on the inward facing side of a wall of the compartment box 2. It should be understood that the photobiomodulation device 6 may be placed anywhere inside the hive 1, 1′ and that multiple photobiomodulation devices 6, 6′ may be used.

To perform the method as discloses, a system for exposing pollinators to photobiomodulation treatment is provided. The system comprises an artificial hive 1, 1′ and at least a photobiomodulation device 6 situated inside the hive 1, 1′ capable of exposing the pollinators for predetermined exposure intervals and predetermined fluence irradiation. The device 6 may comprise at least one light or laser source capable of emitting stimulated emission of radiation or at a device comprising a light emitting diode (LED) capable of emitting light with a fluence between 28 mW/cm2 to 45 mW/cm2. Furthermore, the system comprises to means to determine the periods of irradiation exposure based on the circadian rhythm of pollinating insects wherein the means comprises at least one of: a weight device 8 to measure the mass of the pollinating insects, a GPS positioning device 9 to determine the location of the hive or a time device 10 capable of register and report time and elapsed time, to determining the time of the year and time of the day. The system may further comprise a power source (not shown). Said power source may be a wired source or a battery source. The system may further comprise a control unit (not shown), wherein the control unit controllers when the photobiomodulation device is to be turned on and/or off, and to calculate, based on the geographical location off the device and the time of the year, the time of sunrise Ts.

In an embodiment the system may further comprise means (not shown) to detect at least one of the impact factors: cold weather, wet and/or dry weather, chemicals or pollution exposure or presence of parasites. Wherein means for detecting cold weather may be a thermometer, and means for detecting wet and/or dry weather may be a humidity sensor, and means for detecting chemicals or pollution may be a chemical detector, and means for detecting the presence of parasites or hostile animals may be a camera and/or a microphone.

FIGS. 3a and 3b illustrates the frames inside the hive 1 with a gathering of pollinators 12a, 12b for two different size of colonies inside the hive. In FIG. 3a the pollinators 12 occupies the area shown in section A that spans three frames 11. This sizes of colony A represents a relatively small colony. In FIG. 3b the pollinators 12 occupies the area shown in section B that spans 7 of the frames 11. To register and determine how many frames the gathering of pollinators span, the method can be employed to either lengthen or shorten the time of the light irritation exposure based on the change of the size of the colony.

FIG. 4 is a graph illustrating the typical rise and fall of the size of a colony of bees during a year. As an alternative to measure the size of the colony by counting, weighting, measuring with a sensor device or observing, the system and method might also be used with estimates wherein the duration of the exposure is increased from T2 to T3 when the when it is estimated that the size of the colony is growing. The graph is an illustration for a year at a specific location, and as the seasons for summer and winter are dependent on the geographical location, therefore this graph is only an example and the information it reads will vary for other locations. Because of the different climates based on geographical locations, terms such as summer season and winter season is used herein to describe the season for which a colony normally grows in size and the season for which a colony normally decreases in size. In FIG. 4, the summer season is from April to august, and winter season is from October to February. The size of the colony may be sign of the state of the colony or the general health of the colony. Furthermore, the state of the colony may be determined by the presence of impact factors.

Although specific embodiments of the invention have been described and illustrated herein, it is recognized that modifications and variations may readily occur to those skilled in the art, and consequently, it is intended that the claims be interpreted to cover such modifications and equivalents.

### REFERENCE NUMERALS

1, 1′ Hive
2 Hive compartment box, brood box
4 Entrance chamber box, bottom board
5 Entrance
6 light device
7 Top cover
8 Weight device
9 GPS positioning device
10 Timing device
11 Frames inside hive
12 Group of pollinators

1. A method for exposing pollinating insects in a hive to photobiomodulation, wherein the method is performed by a photobiomodulation system comprising a device that emits infrared light with a radiant energy received by a surface per unit area over time between 28 mW/cm2 and 45 mW/cm2, and a configurable schedule system, the device being adapted to be situated inside the hive to expose the pollinating insects for predetermined exposure times of day, at intervals of predetermined radiant energy, wherein the predetermined exposure times of day, a duration, and the intervals of predetermined radiant energy are determined by at least one of: a circadian rhythm of pollinating insects, a time of year, a location of the hive, a number of individual pollinating insects in the hive, weather conditions, or external impact factors.

2. The method according to claim 1, wherein the method further comprises:
determining the predetermined exposure times of day and the duration to selectively illuminate the pollinating insects when the circadian rhythm of the pollinating insects is most receptive to photobiomodulation, and not to illuminate the pollinating insects when the circadian rhythm of the pollinating insects is less receptive to photobiomodulation,
wherein determining the predetermined exposure times of day and the duration comprises:
determining a time of sunrise (Ts), wherein the time of sunrise is determined by a geographical location of the hive and the time of the year, and
determining a size of the hive of pollinating insects or the number of individual pollinating insects inside the hive by a first measure,
wherein for the first measure the device is turned on to irradiate the insects for a first predetermined time Ts+T1, and the device is turned off after a second predetermined time Ts+T1+T2.

3. The method according to claim 2, wherein the method further comprises: determining, by a further measure, a further measured size of the hive of pollinating insects in relation to the first measure, wherein:
for the further measured size of the hive of pollinating insects, if the further measure is larger than the first measure, the device is turned on to irradiate the pollinating insects for the first predetermined time Ts+T1, and the device is turned off after a third predetermined time Ts+T1+T3, wherein T3 is longer than T2, and
if the further measure is smaller than the first measure, the device is turned on to irradiate the pollinating insects for the first predetermined time Ts+T1, and the device is turned off after a fourth predetermined time Ts+T1+T4, wherein T4 is shorter than T2.

4. The method according to claim 2, wherein the method further comprises determining the size of the hive of pollinating insects or the number of individual pollinating insects inside the hive based upon at least one of: a weight of the hive, a type of the pollinating insects, a number of hive frames populated with the pollinating insects in the hive, the time of year, a state of the hive, or one or more sensors or acoustic-based digital solutions.

5. The method according to claim 4, wherein the method further comprises determining if at least one impact factor has occurred, and, if an impact factor has occurred, turning on the device to irradiate for the first predetermined time Ts+T1, and turning off the device after a fifth predetermined time Ts+T1+T5, wherein T5 is longer than T2, T3 or T4.

6. A system for exposing a pollinator colony to photobiomodulation, wherein the system comprises:
a hive;
a photobiomodulation light device and a scheduling system controlling the photobiomodulation light device capable of exposing the pollinator colony for predetermined exposure intervals and predetermined fluence irradiation; and
means to determine periods of irradiation exposure based on a circadian rhythm of the pollinator colony, comprising at least one of:
means to estimate or determine a size of the pollinator colony inside the hive,
a GPS positioning device to determine a geographical location of the hive, or
a timekeeping device to determining a time of year and a time of day.

7. The system according to claim 6, wherein the photobiomodulation light device comprises a light source that emits light with a fluence or a radiant energy received by a surface per unit area over time between 28 mW/cm2 and 45 mW/cm2.

8. The system in accordance with claim 6, wherein the means to estimate or determine the size of the pollinator colony inside the hive are means to determine a number of frames occupied by pollinating insects inside the hive.

9. The system according to claim 8, wherein the means to estimate or determine the size of the pollinator colony inside the hive is a weight device to measure a mass of the pollinating insects.

10. The system according to claim 6, wherein the system further comprises a power source and a control unit, wherein the control unit is to control when the photobiomodulation light device is to be turned on and/or off, and to calculate, based on the geographical location of the photobiomodulation light device and the time of year, a time of sunrise (Ts).

11. The system according to claim 6, wherein the system comprises means to detect impact factors comprising at least one of: temperature, cold weather, wet and/or dry weather, chemical or pollution exposure, or presence of parasites and/or hostile animals.

12. The system according to claim 11, wherein means for detecting the temperature or cold weather is a thermometer, wherein means for detecting wet and/or dry weather is a humidity sensor, wherein means for detecting chemical or pollution exposure may be a chemical detector, and wherein means for detecting the presence of parasites and/or hostile animals may be a camera and/or a microphone.

13. (canceled)
